(19) United States
(12) Patent Application Publication
(10) Pub. No.: US 2025/0189406 A1
(43) Pub. Date: Jun. 12, 2025

(54) SYSTEM AND METHOD FOR THE DETECTION AND CLASSIFICATION OF BEARING DEFECTS FROM NOISE SIGNALS

(71) Applicant: Schaeffler Technologies AG & Co. KG, Herzogenaurach (DE)

(72) Inventors: Balaji Chandrasekaran, Charlotte, NC (US); Matthew Fowler, Canton, OH (US)

(21) Appl. No.: 18/535,481

(22) Filed: Dec. 11, 2023

(51) Int. Cl. G01M 13/045; B07C 5/34; G06T 7/00

(52) U.S. Cl. CPC G01M 13/045; B07C 5/34; G06T 7/0004; G06T 2207/20081; G06T 2207/20084; G06T 2207/30164

(57) ABSTRACT

A bearing defect analysis system includes a bearing diagnostic tool to generate diagnostic data for test bearings, a sorting tool, and a controller. The controller may receive the diagnostic data for the test bearings from the bearing diagnostic tool, generate spectral data for the test bearings based on the diagnostic data for one or more time windows using a multi-taper estimator, assign classifications to the test bearings based on the spectral data using a machine learning classifier, and direct the sorting tool to sort the test bearings based on the classifications. The machine learning classifier may be trained on spectral data for a set of training bearings.

### TECHNICAL FIELD

The present disclosure relates generally to defect detection of bearings and, more particularly, to automated defect detection and classification.

### BACKGROUND

Mechanical bearings are a critical component of many systems. Defects in such bearings may lead to numerous undesirable effects such as, but not limited to, undesirable acoustic signals (e.g., sounds), undesirable vibrations, increased mechanical wear, or a point of failure. It may therefore be desirable to identify and/or classify bearing defects during a manufacturing process. For example, identifying defects and/or classifying identified defect types may mitigate problems in upstream processes or products including the bearings.

Bearing performance may be characterized using a testing system that operates a bearing and provides diagnostic data on operational parameters such as, but not limited to, vibration and/or velocity during operation. The presence of defects in a bearing may alter or introduce signals within this diagnostic data and may serve as a basis for defect identification and/or characterization.

Existing bearing defect detection techniques typically utilize threshold-based approaches applied to time-series or simple frequency-domain representations of bearing diagnostic data and further typically require manual intervention. For example, an existing bearing defect detection technique may apply a Fourier Transform technique (e.g., a discrete Fourier Transform (DFT) technique, a Fast Fourier Transform (FFT) technique, or the like) to identify amplitude levels at various frequencies within the diagnostic data. Such an existing technique may then identify defects based on thresholds applied to certain frequencies or frequency band ranges. As an illustration, a defect may be detected if a strength of a characteristic frequency exceeds a threshold value. These threshold levels may be adjusted whenever there are changes in the underlying manufacturing process changes by manually collecting data and setting thresholds based on outlier rejection methods (e.g., corresponding to datapoints that are located further than two standard deviations above or below the mean as an outlier). However, such techniques may require substantial manual intervention by an operator and/or may provide limited ability to characterize different defect types. For example, this approach may produce a substantial number of false rejects, which may allow defective bearings to reach the end customers.

Some alternative existing bearing defect detection techniques attempt to generate machine learning and/or deep learning models to identify defects based on raw diagnostic data. However, existing approaches typically require large training datasets, high-end computational resources, high-end measurement sensors, and/or massive decimation of the raw data and are thus unsuitable for many practical applications.

There is therefore a need to develop systems and methods to cure the above deficiencies.

### SUMMARY

A system is disclosed in accordance with one or more illustrative embodiments of the present disclosure. In embodiments, the system includes a bearing diagnostic tool to generate diagnostic data for test bearings. In embodiments, the system includes a sorting tool. In embodiments, the system includes a controller communicatively coupled to the bearing diagnostic tool and the sorting tool. In embodiments, the controller receives the diagnostic data for the test bearings from the bearing diagnostic tool. In embodiments, the controller generates spectral data for the test bearings based on the diagnostic data for one or more time windows using a multi-taper estimator. In embodiments, the controller assigns classifications to at least some of the test bearings based on the spectral data using a machine learning classifier, where the machine learning classifier is trained on spectral data for a set of training bearings. In embodiments, the controller directs (e.g., via one or more control signals) the sorting tool to sort at least some of the test bearings based on the classifications.

A method is disclosed in accordance with one or more illustrative embodiments of the present disclosure. In embodiments, the method includes generating diagnostic data for test bearings. In embodiments, the method includes generating spectral data for the test bearings based on the diagnostic data for one or more time windows using a multi-taper estimator. In embodiments, the method includes assigning classifications to at least some of the test bearings based on the spectral data using a machine learning classifier, where the machine learning classifier is trained on spectral data for a set of training bearings. In embodiments, the method includes directing (e.g., via one or more control signals) a sorting tool to sort at least some of the test bearings based on the classifications.

A system is disclosed in accordance with one or more illustrative embodiments of the present disclosure. In embodiments, the system includes a bearing diagnostic tool configured to generate diagnostic data for test bearings. In embodiments, the system includes a sorting tool. In embodiments, the system includes a controller communicatively coupled to the bearing diagnostic tool and the sorting tool. In embodiments, the controller receives the diagnostic data for the test bearings from the bearing diagnostic tool. In embodiments, the controller generates spectral data for the test bearings based on the diagnostic data for one or more time windows using a multi-taper estimator. In embodiments, the controller assigns classifications to the test bearings based on the spectral data using two or more machine learning classifiers, where the two or more machine learning classifiers are trained on spectral data for a set of training bearings. In embodiments, the controller directs (e.g., via one or more control signals) the sorting tool to sort at least some of the test bearings based on the classifications.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram of a defect analysis system, in accordance with one or more embodiments of the present disclosure.

FIG. 2A illustrates a process flow diagram depicting a method of bearing defect analysis, in accordance with one or more embodiments of the present disclosure.

FIG. 2B illustrates a process flow diagram depicting a first series of sub-steps associated with the step of assigning classifications to test bearings based on the spectral data, in accordance with one or more embodiments of the present disclosure.

FIG. 2C illustrates a process flow diagram depicting a second series of sub-steps associated with the step of assigning classifications to at least some of the test bearings based on the spectral data, in accordance with one or more embodiments of the present disclosure.

FIG. 3 illustrates a conceptual diagram depicting the generation of spectral data using a multi-taper spectral estimator, in accordance with one or more embodiments of the present disclosure.

FIG. 4 illustrates a series of plots depicting diagnostic data and corresponding spectral data for a bearing with no identified defects, in accordance with one or more embodiments of the present disclosure.

FIG. 5 illustrates a series of plots depicting diagnostic data and corresponding spectral data for a bearing with a dent defect, in accordance with one or more embodiments of the present disclosure.

FIG. 6 illustrates a series of plots depicting diagnostic data and corresponding spectral data for a bearing with a needle defect, in accordance with one or more embodiments of the present disclosure.

FIG. 7 illustrates a series of plots depicting diagnostic data and corresponding spectral data for a bearing with a raceway dent defect, in accordance with one or more embodiments of the present disclosure.

FIG. 8 illustrates a plot of frequency-domain spectral data depicting several frequency bands, in accordance with one or more embodiments of the present disclosure.

FIG. 9 illustrates a plot depicting a distribution of values of a relative frequency metric including a relative power between two frequency bands, in accordance with one or more embodiments of the present disclosure.

FIG. 10 illustrates a plot depicting a distribution of values of a relative frequency metric including a mean frequency, in accordance with one or more embodiments of the present disclosure.

FIG. 11 illustrates a plot depicting a distribution of values of a relative frequency metric including a spectral entropy in a particular band, in accordance with one or more embodiments of the present disclosure.

FIG. 12 illustrates a multiclass confusion matrix depicting the accuracy of classification using multiple relative frequency metrics, in accordance with one or more embodiments of the present disclosure.

FIG. 13 illustrates a multiclass confusion matrix depicting the accuracy of classification using spectrogram images as inputs to an image-based deep learning classifier, in accordance with one or more embodiments of the present disclosure.

FIG. 14A illustrates a series of activation maps associated with spectrogram images from bearings including dents provided by an image-based deep learning classifier, in accordance with one or more embodiments of the present disclosure.

FIG. 14B illustrates a series of activation maps associated with spectrogram images from bearings including raceway dents provided by an image-based deep learning classifier, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to systems and methods providing bearing defect detection and/or classification based on non-parametric analysis of vibration signals coupled with a machine learning classifier. Embodiments of the present disclosure are further directed to automatically sorting bearings based on the detection and/or classification of defects. For example, a sorting tool may automatically direct bearings with different classifications (or groups of classifications) to different physical locations.

It is contemplated herein that machine learning classifiers may be well-suited for the identification and/or classification of bearing defects, but it may be desirable to limit the dimensionality and/or amount of data provided to such classifiers for practical considerations. For example, advanced machine learning classifiers may require substantial computational resources and/or run-times, which may not be practical in high-volume manufacturing environments. Limiting the dimensionality and/or amount of data provided to such classifiers in a way that maintains robustness and accuracy may provide the benefits of machine learning classifiers in a manner suitable for many applications.

Embodiments of the present disclosure utilize non-parametric spectral estimation techniques such as, but not limited to, multi-taper spectral estimation techniques to provide a frequency-domain and/or time-frequency representation of diagnostic data. Multi-taper spectral estimation over a selected time window may provide a frequency-domain representation of diagnostic data, which may be referred to as power spectral density data or more simply as spectral data. Multi-taper spectral estimation over multiple overlapping or non-overlapping time windows may further provide a time-frequency domain representation of the diagnostic data and may represent a temporal evolution of frequencies present in the diagnostic data. It is contemplated herein that multi-taper spectral estimation may be particularly suitable for balancing frequency resolution with signal variance and may be more robust than alternative frequency analysis techniques including, but not limited to, discrete Fourier Transform (DFT) techniques, fast Fourier Transform (FFT) techniques, or short-time Fourier Transform (STFT) techniques.

Embodiments of the present disclosure further classify bearings using one or more machine learning classifiers based on the frequency domain and/or time-frequency domain representations of the diagnostic data generated using multi-taper spectral estimation. Some embodiments of the present disclosure are directed to training and using a machine learning classifier to classify defects based on a set of relative frequency metrics (e.g., features) of the diagnostic data rather than the diagnostic data itself. For example, a relative frequency metric may provide a comparison of two properties of the diagnostic data. Examples of relative frequency metrics include, but are not limited to, a ratio of power in one frequency band to another frequency band, a ratio of power in one frequency band to total power (e.g., total spectral power), a log-scale power ratio, a frequency-weighted mean of the spectral data (e.g., center of weight of the spectral data), or spectral entropy in a given band or of the entire spectral data. It is contemplated herein that the relative frequency metrics may capture essential aspects of the impact of bearing defects on the diagnostic data and may substantially reduce the dimensionality and complexity of a required machine learning classifier. Some embodiments, of the present disclosure are directed to training and using an image-based machine learning classifier (e.g., an image-based deep learning classifier) to classify defects based on spectrogram images generated through multi-taper spectral estimation. It is contemplated herein providing spectrogram data in the form of images may robustly downsample the spectrogram data (e.g., based on a resolution used) while preserving essential information provided by the multi-taper technique, which may beneficially ease the required computational resources and/or throughput. Additionally, spectrogram images may include complex time-frequency domain patterns associated with bearing defects and are suitable as inputs to image-based machine learning classifiers. For example, recent advancements in computer vision algorithms incorporating transfer learning and vision architectures such as, but not limited to, ResNet, region-based convolutional neural network (RCNN), you only look once (YOLO), residual network (ResNet), or an inception Net (or a variant thereof such as an Inception-ResNet) may be utilized for bearing defect identification and/or classification.

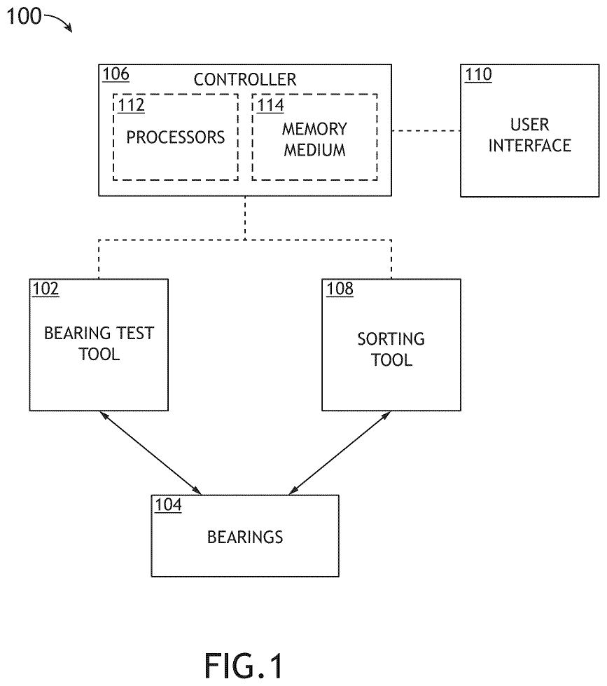

Referring now to FIGS. 1-14B, systems and methods for bearing defect analysis and sorting are described in greater detail, in accordance with one or more embodiments of the present disclosure.

FIG. 1 illustrates a block diagram of a defect analysis system 100, in accordance with one or more embodiments of the present disclosure.

In embodiments, a defect analysis system 100 includes a bearing test tool 102 to provide diagnostic data for bearings 104, a controller 106 to identify and/or classify defects on the bearings 104 based on the diagnostic data, and a sorting tool 108 to physically sort the bearings 104 based on the presence and/or classification of defects. In embodiments, the defect analysis system 100 includes a user interface 110, which may provide (e.g., display) data to a user and/or may receive input from a user.

The controller 106 may be communicatively coupled to any components of the defect analysis system 100 and/or external systems. The controller 106 may further include one or more processors 112 configured to execute a set of program instructions maintained in a memory medium 114, or memory that may cause the processors 112 to perform various actions. In this way, the controller 106 may direct (e.g., through one or more control signals) and/or receive data from any components or sub-systems of the defect analysis system 100 such as, but not limited to, the bearing test tool 102 or the sorting tool 108. The controller 106 may thus be configured to perform any of the various method or process steps described throughout the present disclosure.

For example, the controller 106 may receive time-domain diagnostic data of bearings 104 under test (e.g., test bearings 104) from the bearing test tool 102 and implement multi-taper spectral estimation to generate frequency domain and/or time-frequency domain representations of the diagnostic data. As another example, the controller 106 may assign classifications to the test bearings 104 indicative of the presence of defects and/or different types of defects using one or more machine learning classifiers. As another example, the controller 106 may pre-process the frequency domain and/or time-frequency domain representations of the diagnostic data to provide suitable inputs for one or more machine learning classifiers. As an illustration, the controller 106 may generate values of relative frequency metrics and/or spectrogram images based on the diagnostic data of bearings 104. As another example, the controller 106 may train one or more machine learning classifiers with training data associated with training bearings 104. For instance, the training data may include values of relative frequency metrics and/or spectrogram images based on the diagnostic data of training bearings 104. The training data may further include labels indicative of the presence or classification of known defects on the training bearings 104. In this way, the controller 106 may implement supervised learning, reinforcement learning, or any other learning variant incorporating known information.

The sorting tool 108 may physically sort bearings 104 into any number of groups based on the classifications assigned by the controller 106 (e.g., when implementing one more machine learning classifiers). Notably, the combined operation of the bearing test tool 102, the controller 106, and the sorting tool 108 may provide automated physical sorting of bearings 104 based on identification and/or classification of defects without requiring direct user intervention.

For example, the controller 106 may provide binary classification of bearings 104 into a first class representing bearings 104 that satisfy quality metrics (e.g., good bearings) and a second class representing bearings 104 that fail to satisfy the quality metrics (e.g., defective bearings). The sorting tool 108 may then physically reject (e.g., kick out) bearings 104 in the second class. As another example, the controller 106 may group bearings 104 into a class including bearings with no identified defects and two or more classes associated with different defect types. The sorting tool 108 may then physically sort the bearings based on these classes. For instance, the sorting tool 108 may separate bearings 104 with no identified defects from all other bearings 104, but may provide data associated with the various defect classes for additional testing and/or analysis (e.g., via the user interface 110). In another instance, the sorting tool 108 may physically separate bearings 104 into different locations based on each of the different classes.

The defect analysis system 100 may utilize the user interface 110 to provide any type of information to a user and/or receive any type of input from a user. For example, the defect analysis system 100 may display various data including, but not limited to, the identification of defects, any identified types of defects, any classes being assigned based on defects, quantities of bearings 104 in any class, or status information (e.g., of the bearing test tool 102, the sorting tool 108, confidence of classification performance, or the like). As another example, the defect analysis system 100 may utilize user input to control various parameters or settings. For instance, the defect analysis system 100 may receive instructions via the user interface 110 regarding whether to perform binary sorting (e.g., of acceptable/unacceptable bearings 104) or multi-class sorting.

The various components of the defect analysis system 100 are now described in greater detail, in accordance with one or more embodiments of the present disclosure.

The bearing test tool 102 may include any type of tool known in the art suitable for generating diagnostic data on bearings 104. Further, the bearing test tool 102 may generate diagnostic data for bearings 104 of any type, shape, or size known in the art. As a non-limiting illustration, the bearing test tool 102 may generate diagnostic data for rolling bearings 104, which may include rolling elements (e.g., balls, cylinders, or the like) between rotating elements. It is contemplated herein that many designs of bearings 104 may be known in the art and that the scope of the present disclosure is not limited to the characterization of any particular type of bearing 104.

The bearing test tool 102 may generate diagnostic data using any operating principle known in the art. For example, the bearing test tool 102 may operate a bearing 104 under test by inducing motion of one or more elements of the bearing 104 with continuous or varying velocity. The diagnostic data may be any data suitable for characterizing operation of a bearing 104. For example, diagnostic data may include vibrational data, which may be associate with vibration of any components of the bearing 104 itself and/or any components of the bearing test tool 102 as a result of operation of the bearing 104. As another example, diagnostic data may include data associated with motion of any elements of the bearing 104 and/or any components of the bearing test tool 102 as a result of operation of the bearing 104. As another example, diagnostic data may include acoustic data captured as a result of operation of the bearing 104.

The sorting tool 108 may include any component or combination of components known in the art suitable for physically moving or directing bearings 104. For example, the sorting tool 108 may physically move selected bearings 104 using any technique known in the art including, but not limited to, actuating fins, bars, valves, doors, kickers, or pickers. The sorting tool 108 may further include or be used in conjunction with a conveyor belt or any other suitable motion-controlling device suitable for transporting bearings 104. In this way, the sorting tool 108 may process a stream of bearings 104.

The sorting tool 108 may operate through selective motion of any bearings 104 and/or through selective inaction with respect to any bearings 104. For example, the sorting tool 108 may selectively direct one or more bearings 104 into one or more available hoppers or piles for collection. As another example, the sorting tool 108 may selectively leave some bearings 104 untouched (e.g., on a conveyor belt). In this way, sorting may be provided through selective action or inaction to each bearing 104 (or at least some bearings 104).

The user interface 110 may include any component or combination of components known in the art suitable for providing information to a user and/or receiving inputs from a user. For example, the user interface 110 may include, but is not limited to, one or more desktops, laptops, tablets, and the like. In embodiments, the user interface 110 includes a display used to display data of the defect analysis system 100 to a user. The display of the user interface 110 may include any display known in the art. For example, the display may include, but is not limited to, a liquid crystal display (LCD), an organic light-emitting diode (OLED) based display, or a CRT display. Those skilled in the art should recognize that any display device capable of integration with a user interface 110 is suitable for implementation in the present disclosure. In embodiments, a user may input selections and/or instructions responsive to data displayed to the user via a user input device of the user interface 110 such as, but not limited to, a keyboard, a mouse, a touchscreen, or an audio interface (e.g., a voice interface suitable for accepting audio commands from a user).

The one or more processors 112 of the controller 106 may include any processor or processing element known in the art configured to execute algorithms and/or instructions. For the purposes of the present disclosure, the term “processor” may encompass any device having one or more processing or logic elements such as, but not limited to, one or more micro-processor devices, one or more application specific integrated circuit (ASIC) devices, one or more field programmable gate arrays (FPGAs), one or more digital signal processors (DSPs), or one or more Graphical Processing Units (GPUs). In this sense, the one or more processors 112 may include any device configured to execute algorithms and/or instructions (e.g., program instructions stored in the memory medium 114). In embodiments, the one or more processors 112 may be embodied as a desktop computer, mainframe computer system, workstation, image computer, parallel processor, networked computer, tablet, mobile device, or any other computer system configured to execute a program configured to operate or operate in conjunction with the defect analysis system 100, as described throughout the present disclosure. Moreover, different subsystems of the defect analysis system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 106 may be housed in a single housing or may have components distributed within multiple housings. In this way, any elements or combination of elements may be separately packaged as portions of a controller 106 suitable for integration into the defect analysis system 100.

The memory medium 114 may include any storage medium known in the art suitable for storing program instructions executable by the associated one or more processors 112. For example, the memory medium 114 may include a non-transitory memory medium. By way of another example, the memory medium 114 may include, but is not limited to, a read-only memory (ROM), a random-access memory (RAM), a magnetic or optical memory device (e.g., disk), a magnetic tape, a solid-state drive and the like. It is further noted that the memory medium 114 may be housed in a common controller housing with the one or more processors 112. In embodiments, the memory medium 114 may be located remotely with respect to the physical location of the one or more processors 112 and the controller 106. For instance, the one or more processors 112 of the controller 106 may access a remote memory (e.g., server), accessible through a network (e.g., internet, intranet and the like).

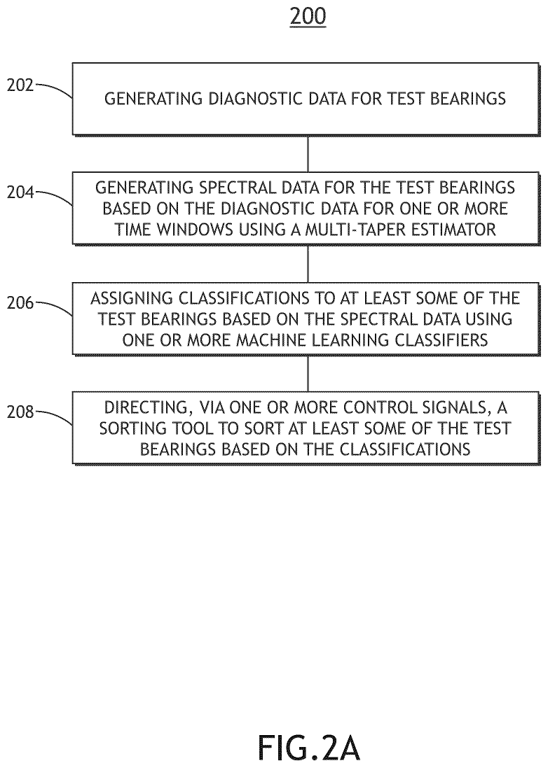

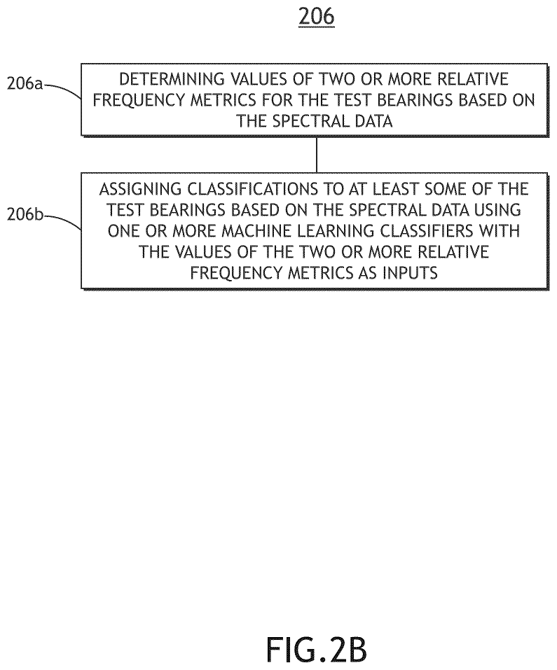

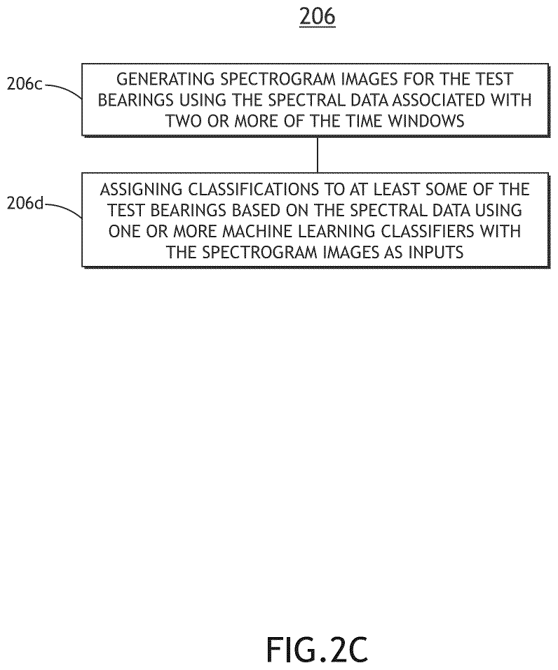

Referring now to FIGS. 2A-2C, methods for defect characterization and sorting are described, in accordance with one or more embodiments of the present disclosure.

FIG. 2A illustrates a process flow diagram depicting a method 200 of bearing defect analysis, in accordance with one or more embodiments of the present disclosure. The embodiments and enabling technologies described previously herein in the context of the defect analysis system 100 should be interpreted to extend to the method 200. For example, various components of the defect analysis system 100 may implement any or all steps of the method 200. However, the method 200 is not limited to the architecture of defect analysis system 100.

In embodiments, the method 200 includes a step 202 of generating diagnostic data for test bearings 104 (e.g., bearings to be tested for defects). For example, the step 202 may include generating diagnostic data with the bearing test tool 102. The diagnostic data may include any type or combination of data suitable for characterizing the bearings 104 such as, but not limited to, vibration data, motion data, or acoustic data. In embodiments, the diagnostic data includes digitized or analog time-series data.

In embodiments, the method 200 includes a step 204 of generating spectral data for the test bearings 104 based on the diagnostic data for one or more time windows using a multi-taper estimator. For example, the spectral data may correspond to a power spectral density of the diagnostic data, or an estimate thereof, generated using a multi-taper estimator.

It is contemplated herein that it may be desirable to characterize the diagnostic data in a frequency domain and/or in a time-frequency domain. In particular, it is contemplated that a physical defect on one portion of a bearing 104 may generation vibration, motion, acoustic signals, or the like when the defect is in contact with another portion of the bearing 104. As a result, operation of the bearing may introduce periodic, semi-periodic, and/or quasi-periodic signals in the diagnostic data that may be observed more readily in a frequency domain or a time-frequency domain. Further, different types of defects and/or defects on different components may introduce different characteristic patterns in the frequency domain and/or the time-frequency domain.

It is further contemplated herein that non-parametric spectral estimation techniques such as a Fourier Transform, a Discrete Fourier Transform, a Fast Fourier Transform, or the like may result in a biased estimation of a power spectral density of diagnostic data in which frequency peaks are broadened, where the amount of broadening worsens as the signal timespan shortens. The use of a windowing function in such an analysis may reduce bias, but typically at the expense of signal variance (e.g., sidelobes associated with each frequency peak that combine across the signal).

A multi-taper estimator is a non-parametric spectral estimation technique that enables balancing of bias (e.g., spectral broadening) and variance (e.g., sidelobes) through averaging multiple Fourier Transforms of the diagnostic data obtained using different window functions. This signal averaging may be in the form of a weighted average in some cases.

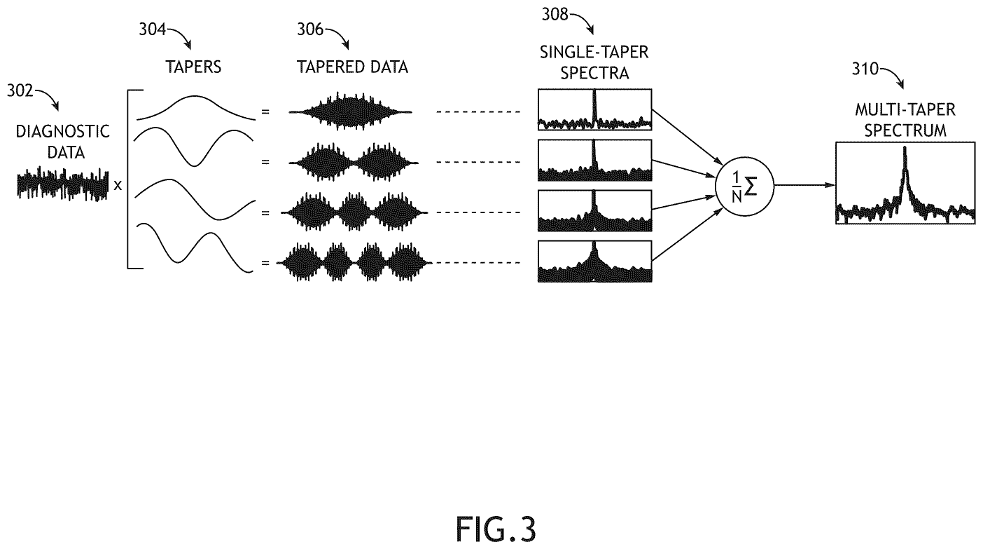

FIG. 3 illustrates a conceptual diagram depicting the generation of spectral data using a multi-taper spectral estimator, in accordance with one or more embodiments of the present disclosure.

In FIG. 3, time-series diagnostic data 302 is individually windowed by multiple taper functions 304 to generate multiple sets of tapered data 306. The taper functions 304 may be any suitable windowing functions and the particular taper functions 304 illustrated in FIG. 3 are intended merely as illustrations and should not be interpreted as limiting on the scope of the present disclosure. In embodiments, the taper functions 304 are selected to be orthogonal such that the resulting sets of tapered data 306 are independent. For example, the taper functions 304 may correspond to, but are not required to be, discrete prolate spheroidal sequences (DPSS), which are also known as Slepian windows.

A single-taper spectrum 308 is then generated for each set of tapered data 306 using any suitable technique such as, but not limited to, a Fourier Transform analysis (e.g., DFT, FFT, or the like). For example, each single-taper spectrum 308 may correspond to a squared modulus of a Fourier Transform of the diagnostic data 302 (e.g., |FFT|²) windowed by the associated taper function 304.

The single-taper spectra 308 are then averaged to generate a multi-taper spectrum 310, which is used as the spectral data and corresponds to a power spectral density, or estimation thereof, of the diagnostic data 302. The multi-taper spectrum 310 may be generated as a pure average or a weighted average of the single-taper spectra 308. For example, different taper functions 304 may provide different amounts of bias or variance. As a result, a weighted average may provide greater control over the final bias and/or variance present in the multi-taper spectrum 310. Further, the bias and the variance may be balanced through selection of the number of tapers and/or a window size.

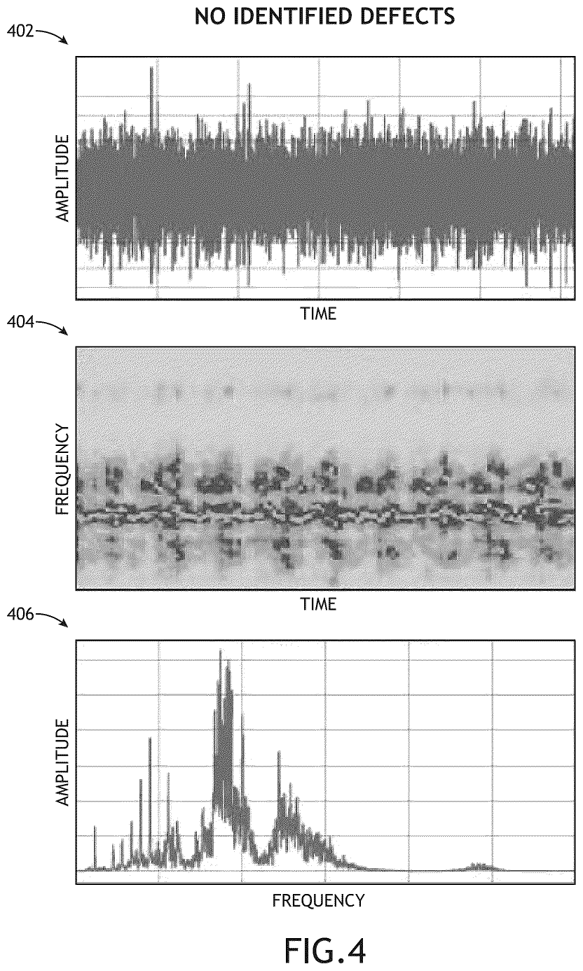

Referring now to FIGS. 4-7, the spectral data generated in step 204 may be in the form of frequency-domain data in the form of a two-dimensional power spectral density and/or time-frequency domain data in the form of a three-dimensional evolution of the power spectral density over time. For example, time-frequency domain data may be generated using a multi-taper estimator for multiple time windows of the diagnostic data, where the multiple time windows may be overlapping or non-overlapping.

FIG. 4 illustrates a series of plots depicting diagnostic data and corresponding spectral data for a bearing 104 with no identified defects, in accordance with one or more embodiments of the present disclosure. In particular, plot 402 is a time-series graph of diagnostic data (e.g., generated in step 202 by a bearing test tool 102), plot 404 is a time-frequency graph of power spectral density as a function of time (e.g., across multiple time windows), and plot 406 is a graph of power spectral density within a single time window.

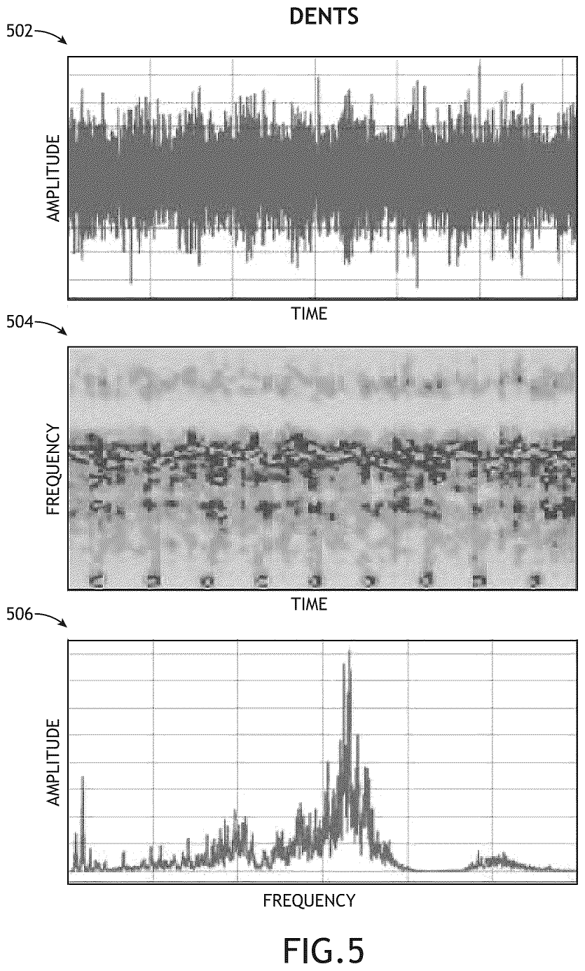

FIG. 5 illustrates a series of plots depicting diagnostic data and corresponding spectral data for a bearing 104 with a dent defect, in accordance with one or more embodiments of the present disclosure. In particular, plot 502 is a time-series graph of diagnostic data (e.g., generated in step 202 by a bearing test tool 102), plot 504 is a time-frequency graph of power spectral density as a function of time (e.g., across multiple time windows), and plot 506 is a graph of power spectral density within a single time window.

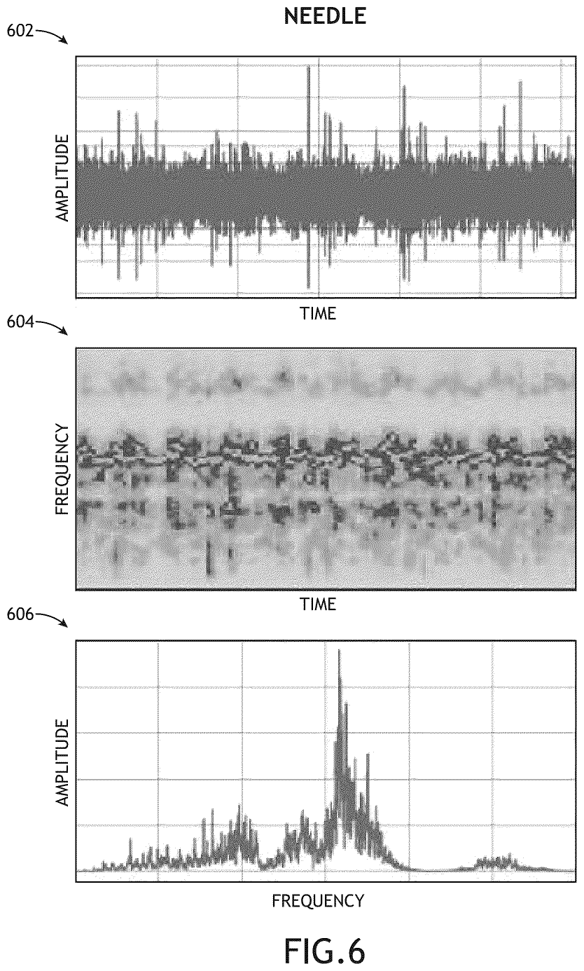

FIG. 6 illustrates a series of plots depicting diagnostic data and corresponding spectral data for a bearing 104 with a needle defect, in accordance with one or more embodiments of the present disclosure. In particular, plot 602 is a time-series graph of diagnostic data (e.g., generated in step 202 by a bearing test tool 102), plot 604 is a time-frequency graph of power spectral density as a function of time (e.g., across multiple time windows), and plot 606 is a graph of power spectral density within a single time window.

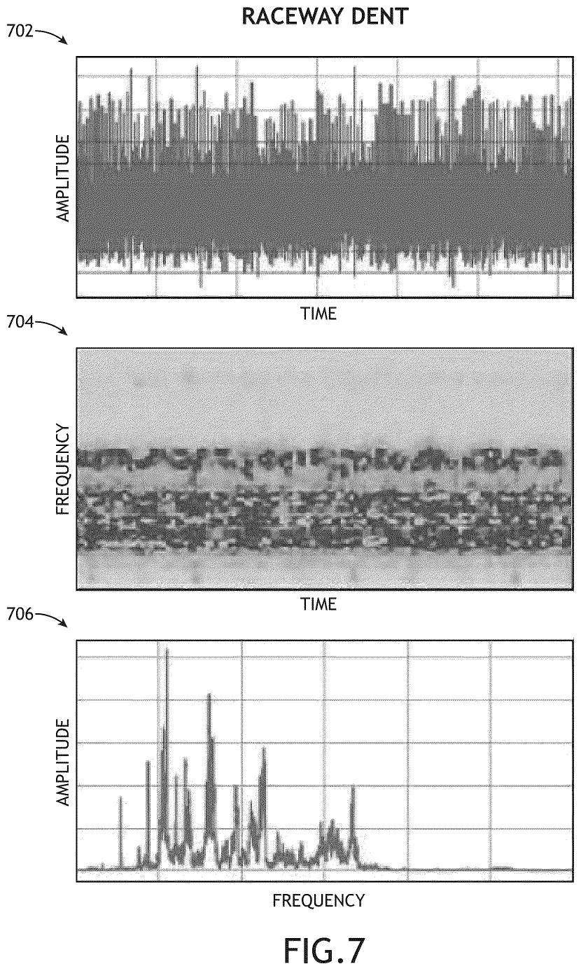

FIG. 7 illustrates a series of plots depicting diagnostic data and corresponding spectral data for a bearing 104 with a raceway dent defect, in accordance with one or more embodiments of the present disclosure. In particular, plot 702 is a time-series graph of diagnostic data (e.g., generated in step 202 by a bearing test tool 102), plot 704 is a time-frequency graph of power spectral density as a function of time (e.g., across multiple time windows), and plot 706 is a graph of power spectral density within a single time window.

Considering FIGS. 4-7 together, several observations regarding the spectral data may be made. As shown in FIG. 4, spectral data associated with a bearing 104 without identified defects may provide a baseline or reference signature. In the particular case illustrated in FIG. 4, the spectral data includes power centered around a primary peak, potentially with smaller surrounding bands. FIGS. 5-7 then show various modifications to the baseline signature as a result of dents which may be characterized by substantial power at additional frequencies (often higher frequencies) than the primary peak illustrated in FIG. 4.

It is contemplated herein that the baseline signature associated with a bearing 104 without identified defects may be highly dependent on the particular design of the bearing 104 as well as the mode of operation of the bearing test tool 102. For example, the primary peak may correspond to a frequency of rotation or movement of the bearing test tool 102 when operating the bearing 104, whereas surrounding peaks may correspond to rotational frequencies of various rotating elements in the bearing 104. Similarly, the impact of any particular defect may be highly dependent on the particular design of the bearing 104, the mode of operation of the bearing test tool 102, and the nature of the defect. In this way, the plots in FIGS. 4-7 are intended merely for illustration and should not be interpreted as limiting.

Referring again to FIG. 2A, in embodiments, the method 200 includes a step 206 of assigning classifications to at least some of the test bearings 104 based on the spectral data using one or more machine learning classifiers.

Various machine learning classifiers may be used to assign classifications to test bearings 104 in step 206. machine learning classifiers may be well-suited for the identification and/or classification of bearing defects. However, advanced machine learning classifiers may require substantial computational resources and/or run-times, which may not be practical in high-volume manufacturing environments in which many bearings 104 must be analyzed and sorted.

In embodiments, the dimensionality and/or amount of data provided to one or more machine learning classifiers are limited in a controlled manner to enable high-throughput operation while balancing cost and complexity.

Referring now to FIG. 2B, FIG. 2B illustrates a process flow diagram depicting a first series of sub-steps associated with the step 206 of assigning classifications to at least some of the test bearings 104 based on spectral data, in accordance with one or more embodiments of the present disclosure. The sub-steps are referred to herein simply as steps. The embodiments and enabling technologies described previously herein in the context of the defect analysis system 100 should be interpreted to extend to the steps depicted in FIG. 2B, but the steps depicted in FIG. 2B are not limited to the architecture of defect analysis system 100.

In embodiments, the step 206 includes a step 206a (e.g., a sub-step) of determining values for relative frequency metrics based on the spectral data and a step 206b of assigning classifications to at least some of the test bearings 104 based on the spectral data using one or more machine learning classifiers with the values of the two or more relative frequency metrics as inputs. In this way, the amount and/or dimensionality of data fed to the machine learning classifier may be substantially reduced. However, it is contemplated herein that proper selection of the relative frequency metrics may nonetheless provide accurate and robust defect classification. In particular, the raw spectral data may have a relatively high variance such that training a machine learning classifier on this raw data may result in learning errors or other issues. Further, training a machine learning classifier on this raw data may require training data set that is impractically or undesirably large. Put another way, the use of relative frequency metrics as disclosed herein may beneficially reduce the variance and dimensionality of inputs to the machine learning classifier. Further, relative frequency metrics may normalize data across multiple samples, which may facilitate robust defect identification and/or classification.

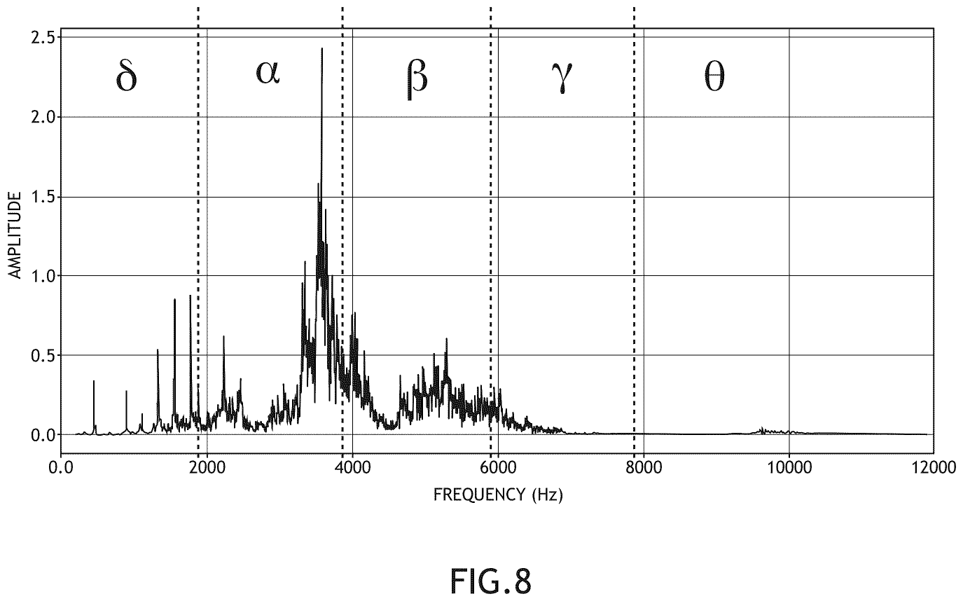

FIG. 8 illustrates a plot of frequency-domain spectral data (e.g., power spectral density over a single time window) depicting several frequency bands, in accordance with one or more embodiments of the present disclosure. In particular, the frequency bands are labeled as δ, α, β, γ, and θ.

A relative frequency metric may include a comparison of two or more properties of the spectral data generated in step 204. The comparison may be in the form of a ratio, a subtraction, or any other suitable form.

For example, a relative frequency metric may correspond to a relative power in one (or more) bands relative to a total power. As an illustration, relative power in the a spectral band may be provided as P(α)/P_{Total}, where P(α) is the power in the α spectral band and P_{Total} is a total spectral power (e.g., a total power across the frequency domain). As another example, a relative frequency metric may correspond to a relative power between two spectral bands (or two sets of spectral bands). For instance, relative power between the γ spectral band and the a spectral band may be provided as P(γ)/P(α). As another example, a relative frequency metric may correspond to a frequency-weighted mean (e.g., a center of weight of the spectral data, a mean frequency, or the like). As another example, a relative frequency metric may correspond to a spectral entropy in a given band or across the entire spectrum. For instance, spectral entropy may be provided as

$$PSE = - {\sum }_{i = 1}^{N} {p}_{i} ln {p}_{i} , \qquad ( 1 )$$

where the subscript i corresponds to a frequency (or a data point corresponding to a frequency), p corresponds to a power at a particular frequency, and N defines the range of frequencies considered.

It is to be understood that the above examples of relative frequency metrics are intended merely as illustrations and should not be interpreted as limiting. Rather, any suitable relative frequency metric may be used. Further, a relative frequency metric may be differentiated from an absolute metric, which may correspond to a value of a single property of the spectral data such as, but not limited to, an amplitude at a single frequency or a power in a single frequency band. It is contemplated herein that the use of relative frequency metrics rather than absolute metrics may provide more robust classifications that do not require (or at least minimize) user intervention.

Any type of machine learning classifier known in the art may be utilized in step 206b such as, but not limited to, a support vector machine classifier, a nearest neighbor classifier, a perceptron, a logistic regression classifier, or a Bayes classifier.

The machine learning classifier may implement any type or combination of types of learning including, but not limited to, supervised learning, unsupervised learning, or reinforcement learning. For example, the machine learning classifier may be trained using relative frequency metrics of a set of training bearings with known defect types (e.g., known classes as labels), where the relative frequency metrics are derived from spectral data generated from diagnostic using a multi-taper estimator. In this way, the machine learning classifier may be trained on data generated using substantially the same techniques and/or tools as used to classify test bearings 104 during a run-time operation. However, this is not a requirement. As another example, the machine learning classifier may be trained using data from external sources or publicly available datasets. As another example, the machine learning classifier may be trained and/or updated based on data associated with returned products and/or data from additional quality testing. In this way, the machine learning classifier may generally be trained using any suitable data sources.

Further, an ensemble combination of machine learning classifiers may be utilized in step 206b. For example, multiple machine learning classifiers or combinations thereof may be trained and then evaluated (e.g., with unseen data from additional bearings with known defects). In this way, the best performing classifier or combination of classifiers may be selected for implementation.

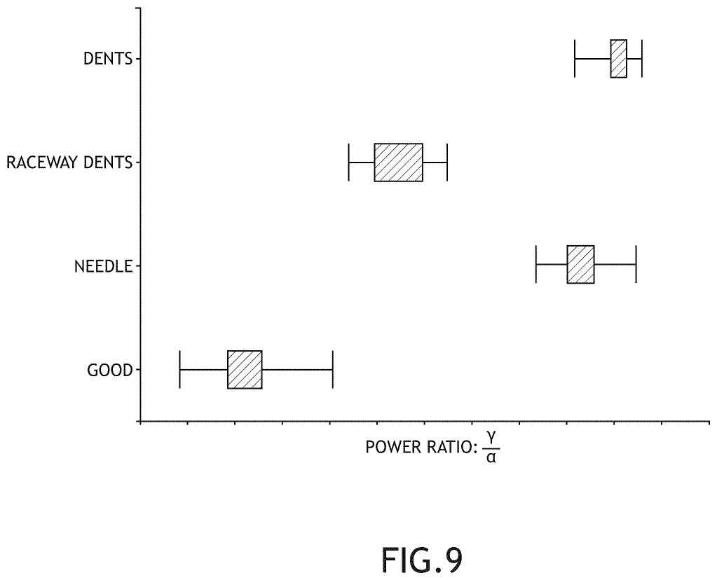

FIGS. 9-11 depict plots illustrating different relative frequency metrics associated with bearings 104 having different defect types (e.g., dents, raceway dents, and needle defects) as well as for bearings 104 with no identifiable defects (e.g., referred to in the figures as “good”). In each plot, the different classes are listed in the vertical axis and the values of the corresponding relative frequency metric are provided as a range of values along the horizontal axis.

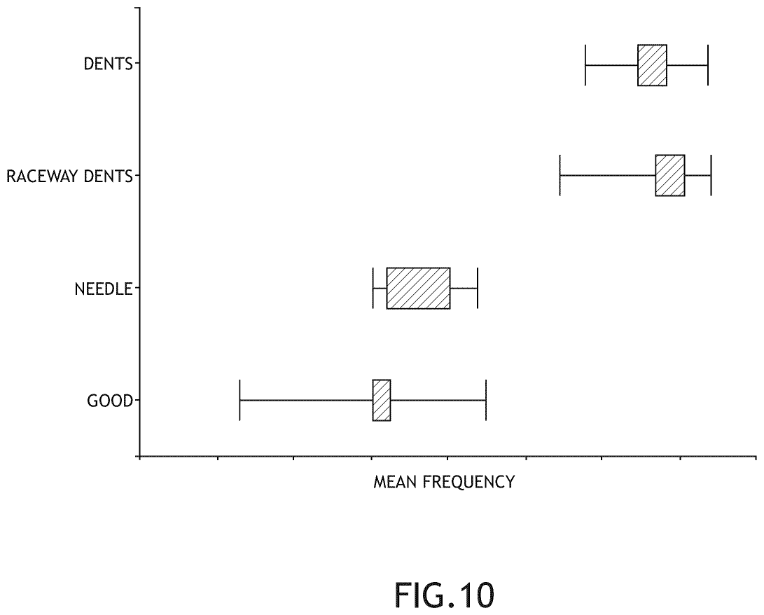

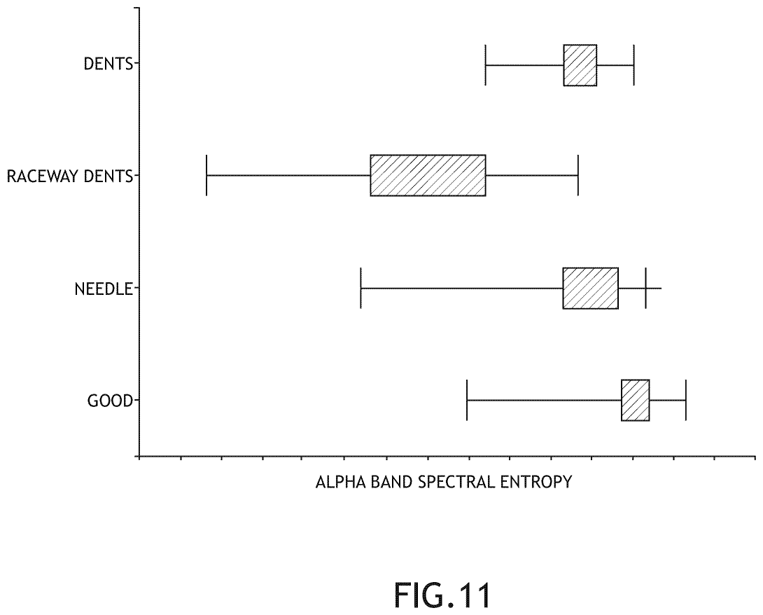

FIG. 9 illustrates a plot depicting a distribution of values of a relative frequency metric including a relative power between two frequency bands (a γ band and an α band), in accordance with one or more embodiments of the present disclosure. FIG. 10 illustrates a plot depicting a distribution of values of a relative frequency metric including a mean frequency (e.g., a frequency-weighted mean), in accordance with one or more embodiments of the present disclosure. FIG. 11 illustrates a plot depicting a distribution of values of a relative frequency metric including a spectral entropy in a particular band (an α band), in accordance with one or more embodiments of the present disclosure.

As depicted in FIGS. 9-11, different types of dents may generally have different values of relative frequency metrics. However, it may be the case that a single relative frequency metric may not necessarily provide sufficient information to identify certain defects or distinguish between certain defect types. Accordingly, it may be desirable to use multiple relative frequency metrics as inputs to a machine learning classifier. In this way, the machine learning classifier may use multi-dimensional classification based on the number of relative frequency metrics used.

As an illustration, the reference metric depicted in FIG. 9 provides relatively good discrimination of good bearings 104 and bearings 104 with raceway dents, but little discrimination between bearings 104 with dents and needle defects (though these defective bearings as a whole may be discriminated as a group from the other classes). FIG. 10 provided discrimination between a first group of good bearings 104 and bearings 104 with needle defects with respect to a second group of bearings 104 with dents and raceway dents. FIG. 11 provides discrimination between bearings 104 and the remainder of the groups. As a result, a multi-dimensional analysis using multiple reference frequency metrics may provide better discrimination than a single reference frequency metric.

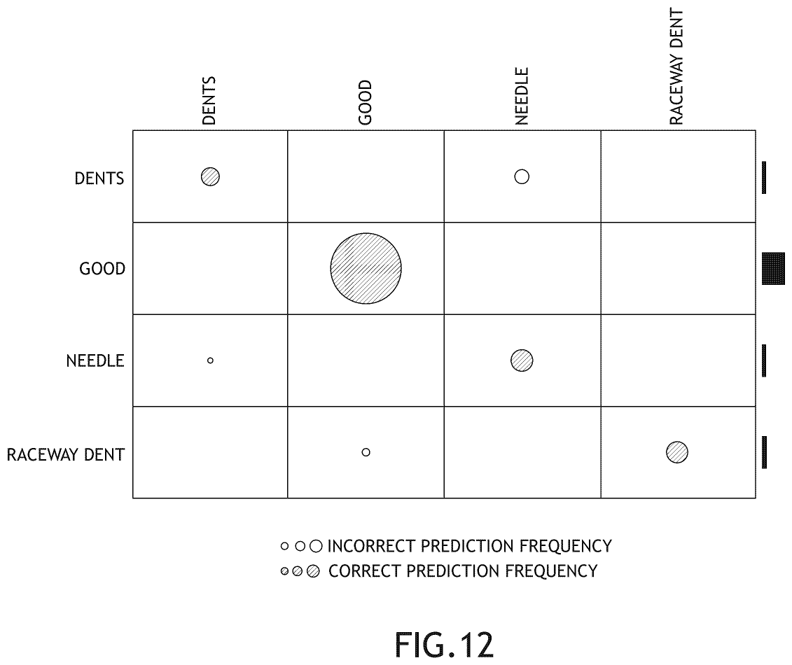

FIG. 12 illustrates a multiclass confusion matrix depicting the accuracy of classification using multiple relative frequency metrics, in accordance with one or more embodiments of the present disclosure. As indicated in FIG. 12, good bearings 104 and defective bearings 104 are discriminated with 100% accuracy in this example. Further, discrimination between defect types is achieved with high accuracy, though discrimination between bearings 104 with dents and needle defects has the highest incorrect prediction frequency.

It is noted that FIGS. 9-12 are shown merely for illustration and should not be interpreted as limiting. Further, the use of additional relative frequency metrics would provide better discrimination between all of the classes. In a general sense, any number of relative frequency metrics may be used to train and use the machine learning classifier. For example, two, three, four, or more relative frequency metrics may be utilized within the spirit and scope of the present disclosure. Further, it is to be understood that the present disclosure is not limited to the illustrated defect types (e.g., dents, missing needles, raceway dents, or the like). Rather, the systems and methods disclosed herein may be extended to any type of defects.

Referring now to FIG. 2C, FIG. 2C illustrates a process flow diagram depicting a second series of sub-steps associated with the step 206 of assigning classifications to at least some of the test bearings 104 based on spectral data, in accordance with one or more embodiments of the present disclosure. The embodiments and enabling technologies described previously herein in the context of the defect analysis system 100 should be interpreted to extend to the steps depicted in FIG. 2C, but the steps depicted in FIG. 2C are not limited to the architecture of defect analysis system 100.

In embodiments, the step 206 includes a step 206c (e.g., a sub-step) of generating spectrogram images for the test bearings 104 using the spectral data associated with two or more of the time windows. For example, spectrogram images are depicted in plots 404, 504, 604, and 704 in FIGS. 4-7 and may depict a temporal evolution of power spectral density of the diagnostic data. In embodiments, step 206 includes a step 206d (e.g., a sub-step) of assigning classifications to at least some of the test bearings 104 based on the spectral data using one or more machine learning classifiers with the spectrogram images as inputs.

The machine learning classifier in this configuration may include any machine learning classifier suitable for classification based on images (e.g., any image-based classifier). For example, the machine learning classifier may be an image-based deep learning classifier such as, but not limited to, a RCNN, a faster-RCNN, a YOLO classifier, a ResNet, or an inception Net (or a variant thereof such as an Inception-ResNet).

The image-based classifier may implement any type or combination of types of learning including, but not limited to, supervised learning, unsupervised learning, or reinforcement learning. For example, the image-based classifier may be trained using spectrogram images for a set of training bearings with known defect types (e.g., known classes as labels), where the spectrogram images are derived from spectral data generated from diagnostic using a multi-taper estimator. In this way, the image-based classifier may be trained on data generated using substantially the same techniques and/or tools as used to classify test bearings 104 during a run-time operation. However, this is not a requirement. As another example, the image-based classifier may be trained using data from external sources or publicly available datasets. As another example, the image-based classifier may be trained and/or updated based on data associated with returned products and/or data from additional quality testing. As another example, the image-based classifier may be trained and/or updated based on defect masters (e.g., defect master data). In this way, the image-based classifier may generally be trained using any suitable data sources.

It is contemplated herein that the use of an image-based classifier (e.g., an image-based deep learning classifier, or the like) may provide numerous advantages in the context of bearing defect detection relative to other deep learning classifiers. For example, providing spectrogram data in the form of images may robustly downsample the spectrogram data while preserving essential information provided by the multi-taper estimator. In particular, the amount of downsampling may be controlled based on the resolution and overlap in time windows of the spectrogram data when generating an image. As a result, providing spectrogram data in the form of images may provide an effective and robust technique for limiting the quantity of data analyzed by the image-based deep learning classifier, which may beneficially reduce the required computational resources. Further, image-based deep learning classifiers are widely used in many applications and may be both actively developed and readily available.

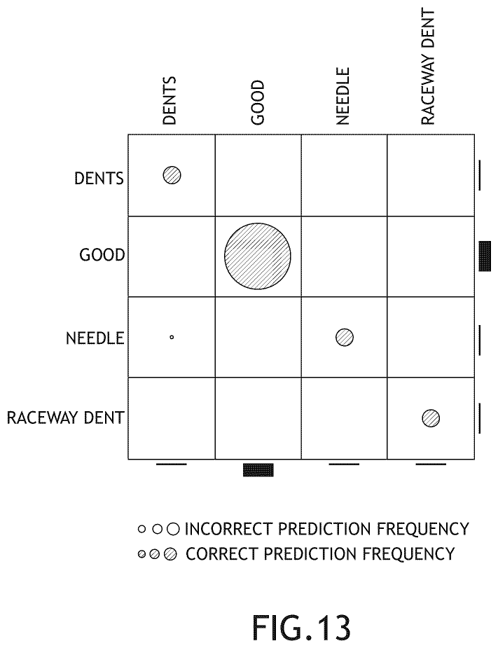

FIG. 13 illustrates a multiclass confusion matrix depicting the accuracy of classification using spectrogram images as inputs to an image-based deep learning classifier, in accordance with one or more embodiments of the present disclosure. In this example, good bearings 104 and defective bearings 104 are discriminated (e.g., identified) with 100% accuracy. Further, discrimination between defect types is achieved with extremely high accuracy, with only a relatively low incorrect prediction frequency between bearings 104 with needle and dent defects. As indicated previously herein, the particular list of defect types is merely illustrative and should not be interpreted as limiting the scope of the present disclosure.

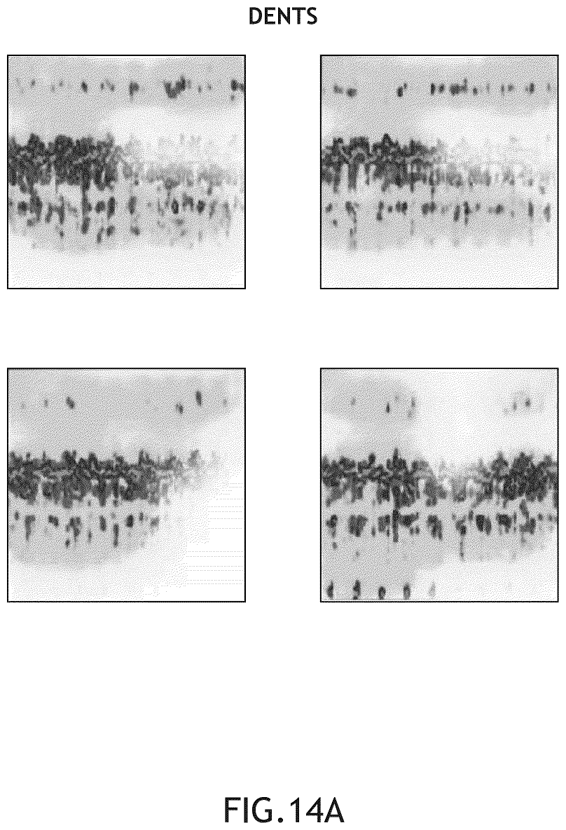

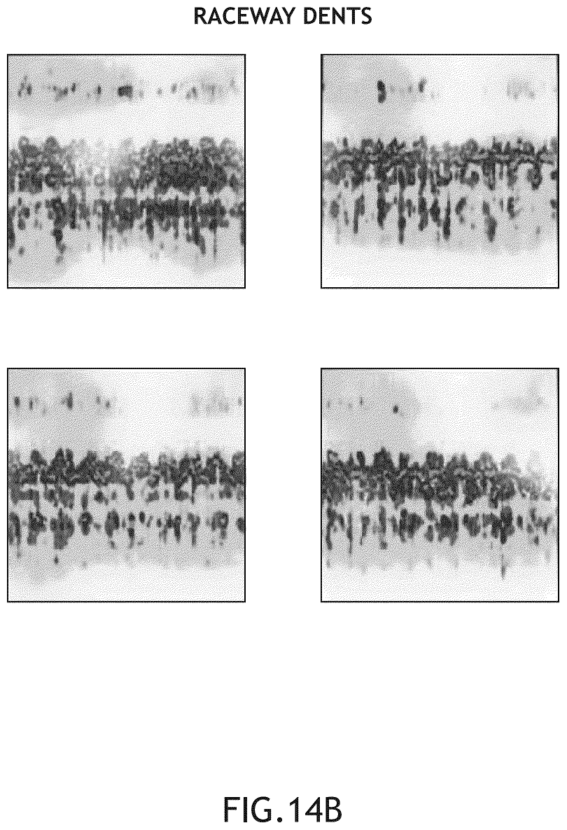

FIG. 14A illustrates a series of activation maps associated with spectrogram images from bearings 104 including dents provided by an image-based deep learning classifier, in accordance with one or more embodiments of the present disclosure. FIG. 14B illustrates a series of activation maps associated with spectrogram images from bearings 104 including raceway dents provided by an image-based deep learning classifier, in accordance with one or more embodiments of the present disclosure. These activation maps depict image regions relied upon at least in part for at least one layer of the deep learning network. Regions not relied on are depicted as white. The activation maps demonstrate how image-based techniques may identify patterns in the time-frequency domain spectrogram data that may be used for defect classification.

Referring again to FIG. 2A, the step 206 may be performed using any number of machine learning classifiers. For example, the step 206 may be performed using both a machine learning classifier that accepts relative frequency metrics as inputs as well as an image-based deep learning classifier that accepts spectrogram images as inputs.

The outputs of multiple machine learning classifiers may be combined to provide a final assignment of classes using any technique known in the art. For example, when multiple machine learning classifiers disagree on a class for a particular test bearing 104, the test bearing 104 may be assigned into an additional class of uncertain classifications. As another example, when multiple machine learning classifiers disagree but a majority (or selected percentage) of machine learning classifiers agree, then the classification assigned by the majority (or selected percentage) of classifiers may be used.

In embodiments, the method 200 includes a step 208 of directing (e.g., via one or more control signals) a sorting tool 108 to sort at least some of the test bearings 104 based on the classifications developed in step 206.

The step 208 may include sorting the test bearings 104 in a variety of ways. For example, the step 208 may include sorting the test bearings 104 into any number of groups, where each group may include any number of classes.

For example, the step 208 may include directing, via the one or more control signals, the sorting tool 108 to reject at least some of the plurality of test bearings 104 having at least one identified defect based on the classifications. As an illustration, the sorting tool 108 may include an actuator to selectively reject any bearing 104 with any identified defect.

As another example, the step 208 may include directing, via the one or more control signals, the sorting tool 108 to sort at least some of the plurality of test bearings 104 by class based on the classifications. In this way, the sorting tool 108 may physically separate the bearings 104 according to their assigned class.

As another example, the step 208 may include directing, via the one or more control signals, the sorting tool 108 to sort at least some of the plurality of test bearings 104 into a first group with bearings that have no identified defects as well as test bearings 104 that have defects deemed to be acceptable in a particular application and further sort the remainder into a second group.

As used herein, directional terms such as “top,” “bottom,” “over,” “under,” “upper,” “upward,” “lower,” “down,” and “downward” are intended to provide relative positions for purposes of description and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 defect analysis system
102 bearing test tool
104 bearings
106 controller
108 sorting tool
110 user interface
112 processors
114 memory medium
302 diagnostic data
304 taper functions
306 tapered data
308 single-taper spectra
310 multi-taper spectrum

What is claimed:

1. A system comprising:
a bearing diagnostic tool configured to generate diagnostic data for a plurality of test bearings;
a sorting tool; and
a controller communicatively coupled to the bearing diagnostic tool and the sorting tool, wherein the controller includes one or more processors configured to execute program instructions stored in a memory medium, wherein the program instructions are configured to cause the one or more processors to:
receive the diagnostic data for the plurality of test bearings from the bearing diagnostic tool;
generate spectral data for the plurality of test bearings based on the diagnostic data for one or more time windows using a multi-taper estimator;
assign classifications to at least some of the plurality of test bearings based on the spectral data using a machine learning classifier, wherein the machine learning classifier is trained on training spectral data for a set of training bearings; and
direct, via one or more control signals, the sorting tool to sort at least some of the plurality of test bearings based on the classifications.

2. The system of claim 1, wherein assigning the classifications to at least some of the plurality of test bearings based on the spectral data using the machine learning classifier comprises:
determining values of two or more relative frequency metrics for the plurality of test bearings based on the spectral data, wherein a particular one of the two or more relative frequency metrics comprises a comparison of two or more properties of the spectral data, wherein the machine learning classifier accepts the values of the two or more relative frequency metrics as inputs.

3. The system of claim 2, wherein the machine learning classifier comprises:
at least one of a support vector machine classifier, a nearest neighbor classifier, a perceptron, a logistic regression classifier, or a Bayes classifier.

4. The system of claim 2, wherein at least one of the two or more relative frequency metrics comprises:
at least one of a ratio of power in a selected spectral band to a total power, a ratio of power in a first spectral band to a second spectral band, a frequency-weighted mean of the spectral data, a spectral entropy of at least a portion of the spectral data.

5. The system of claim 2, wherein the two or more relative frequency metrics comprises:
four or more relative frequency metrics.

6. The system of claim 1, wherein assigning the classifications to at least some of the plurality of test bearings based on the spectral data using the machine learning classifier comprises:
generating spectrogram images for the plurality of test bearings using the spectral data associated with two or more of the one or more time windows, wherein the machine learning classifier accepts the spectrogram images as inputs.

7. The system of claim 6, wherein the machine learning classifier comprises:
an image-based deep learning classifier.

8. The system of claim 6, wherein the machine learning classifier comprises:
at least one of a convolutional neural network, a region-based convolutional neural network (RCNN), a Residual network (ResNet), a faster-RCNN, or a you only look once (YOLO) classifier.

9. The system of claim 1, wherein the diagnostic data comprises:
vibrational data.

10. The system of claim 1, wherein directing, via the one or more control signals, the sorting tool to sort at least some of the plurality of test bearings based on the classifications comprises:
directing, via the one or more control signals, the sorting tool to reject at least some of the plurality of test bearings having at least one identified defect based on the classifications.

11. The system of claim 1, wherein directing, via the one or more control signals, the sorting tool to sort at least some of the plurality of test bearings based on the classifications comprises:
directing, via the one or more control signals, the sorting tool to sort at least some of the plurality of test bearings by class based on the classifications.

12. A method comprising:
generating diagnostic data for a plurality of test bearings;
generating spectral data for the plurality of test bearings based on the diagnostic data for one or more time windows using a multi-taper estimator;
assigning classifications to at least some of the plurality of test bearings based on the spectral data using a machine learning classifier, wherein the machine learning classifier is trained on training spectral data for a set of training bearings; and
directing, via one or more control signals, a sorting tool to sort at least some of the plurality of test bearings based on the classifications.

13. A system comprising:
a bearing diagnostic tool configured to generate diagnostic data for a plurality of test bearings;
a sorting tool; and
a controller communicatively coupled to the bearing diagnostic tool and the sorting tool, wherein the controller includes one or more processors configured to execute program instructions stored in a memory medium, wherein the program instructions are configured to cause the one or more processors to:
receive the diagnostic data for the plurality of test bearings from the bearing diagnostic tool;
generate spectral data for the plurality of test bearings based on the diagnostic data for one or more time windows using a multi-taper estimator;
assign classifications to the plurality of test bearings based on the spectral data using two or more machine learning classifiers, wherein the two or more machine learning classifiers are trained on training spectral data for a set of training bearings; and
direct, via one or more control signals, the sorting tool to sort at least some of the plurality of test bearings based on the classifications.

14. The system of claim 13, wherein assigning the classifications to the plurality of test bearings based on the spectral data using the two or more machine learning classifiers comprises:
determining values of two or more relative frequency metrics for the plurality of test bearings based on the spectral data, wherein a particular one of the two or more relative frequency metrics comprises a comparison of two or more properties of the spectral data, wherein at least a first machine learning classifier of the two or more machine learning classifiers accepts the values of the two or more relative frequency metrics as inputs.

15. The system of claim 14, wherein the first machine learning classifier comprises:
at least one of a support vector machine classifier, a nearest neighbor classifier, a perceptron, a logistic regression classifier, or a Bayes classifier.

16. The system of claim 14, wherein at least one of the two or more relative frequency metrics comprises:
at least one of a ratio of power in a selected spectral band to a total power, a ratio of power in a first spectral band to a second spectral band, a frequency-weighted mean of the spectral data, a spectral entropy of at least a portion of the spectral data.

17. The system of claim 13, wherein assigning the classifications to the plurality of test bearings based on the spectral data using the two or more machine learning classifiers comprises:
generating spectrogram images using the spectral data associated with two or more time windows, wherein at least a second machine learning classifier of the two or more machine learning classifiers accepts the spectrogram images as inputs.

18. The system of claim 17, wherein the second machine learning classifier comprises:
at least one of a convolutional neural network, a region-based convolutional neural network (RCNN), a faster-RCNN, a Residual network (ResNet), or a you only look once (YOLO) classifier.

19. The system of claim 13, wherein assigning the classifications to the plurality of test bearings based on the spectral data using the two or more machine learning classifiers comprises:
generating spectrogram images using the spectral data associated with two or more time windows, wherein at least one of the two or more machine learning classifiers accepts the spectrogram images as inputs.

20. The system of claim 19, wherein the at least one of the two or more machine learning classifiers that accepts the spectrogram images as inputs comprises:
at least one of a convolutional neural network, a region-based convolutional neural network (RCNN), a faster-RCNN, a Residual network (ResNet), or a you only look once (YOLO) classifier.
